(19) United States
(12) Patent Application Publication
(10) Pub. No.: US 2024/0406068 A1
(43) Pub. Date: Dec. 5, 2024

(54) TECHNIQUES FOR DETERMINING NETWORK SUPPORT FOR UE POLICY SECTIONS OVER EPS

(71) Applicant: Lenovo (Singapore) Pte. Ltd., New Tech Park (SG)

(72) Inventors: Roozbeh Atarius, La Jolla, CA (US); Genadi Velev, Darmstadt (DE)

(21) Appl. No.: 18/734,630

(22) Filed: Jun. 5, 2024

Related U.S. Application Data
(60) Provisional application No. 63/506,326, filed on Jun. 5, 2023.

(51) Int. Cl. H04L 41/0894; H04W 8/22

(52) U.S. Cl. CPC H04L 41/0894; H04W 8/22

(57) ABSTRACT

Various aspects of the present disclosure relate to transmitting a request message comprising a first extended protocol configuration options (ePCO) information element (IE). Aspects of the present disclosure relate to receiving a response message comprising a second ePCO IE and determining that an evolved packet system (EPS) supports UE policy sections management based on the second ePCO IE. Aspects of the present disclosure relate to performing a network-requested UE policy management procedure based on the EPS supporting the UE policy sections management.

### TECHNICAL FIELD

The present disclosure relates to wireless communications, and more specifically to techniques for determining network support for user equipment (UE) policy sections management over the evolved packet system (EPS).

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may transmit, e.g., to a network node in an EPS, a request message comprising a first extended protocol configuration options (ePCO) information element (IE), and may receive, e.g., from the network node, a response message comprising a second ePCO IE. In such implementations, the method and apparatuses described herein may determine that the EPS supports a UE policy sections management based on the second ePCO IE, and may perform a network-requested UE policy management procedure based on the EPS supporting the UE policy sections management.

Other implementations of the method and apparatuses described herein may receive, e.g., from a UE, a request message comprising a UE state indication message, wherein the UE state indication message comprises a first ePCO IE, and may determine that the UE supports UE policy sections management based on the first ePCO IE. In such implementations, the method and apparatuses described herein may transmit, to the UE, a response message comprising a second ePCO IE, and may forward the UE state indication message to a session management policy control function (SM-PCF).

### BRIEF DESCRIPTION OF THE DRAWINGS

FIG. 1 illustrates an example of a wireless communication system in accordance with aspects of the present disclosure.

FIG. 2 illustrates an example of a network architecture for interworking between the 5G system (5GS) and the EPS in accordance with aspects of the present disclosure;

FIG. 3 illustrates an example of a protocol stack showing different protocol layers in the UE and network, in accordance with aspects of the present disclosure.

FIG. 4A illustrates an example of a procedure for determining network support for UE policy sections management over EPS, in accordance with aspects of the present disclosure.

FIG. 4B is a continuation of the procedure of FIG. 4A.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 is a flowchart diagram illustrating one embodiment of a method for determining network support for UE policy sections management over EPS.

FIG. 9 is a flowchart diagram illustrating another embodiment of a method for determining network support for UE policy sections management over EPS.

### DETAILED DESCRIPTION

The present disclosure describes systems, methods, and apparatuses for determining network support for UE policy sections management over EPS. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

The third generation partnership project (3GPP) has defined a method for the UE to trigger UE policy association establishment by the SM-PCF. However, this technique requires that the UE and the evolved packet core (EPC) network entities support the extended protocol configuration options (ePCO) information element (IE). This this technique requires that the UE and the EPC network entities support the UE policy sections managements.

At the time of UE attach to the EPS network, the UE cannot determine whether the EPC network entities support the ePCO IE, which is necessary for the UE policy sections managements. In certain embodiments, the EPC network entities may include a mobility management entity (MME), a serving gateway (S-GW), a combined session management function (SMF) and Packet Data Network (PDN) gateway (P-GW) control-plane entity (SMF+PGW-C), or some combination thereof. In certain embodiments, upon receipt of the response to the attach request, the UE may determine from the contents of the response message whether there is an end-to-end support for the ePCO IE.

However, since the procedure for the UE-initiated UE state indication procedure described in 3GPP technical specification (TS) 24.501, is originally for the 5GS network which always supports the UE policy sections management, there is not any indication in the response of the EPS attach request that the UE can find out whether the EPS network supports for the UE policy sections managements. Rather, the UE can only find out whether the EPS network supports UE policy sections management if the UE at some point receives the UE policy sections from the network.

Described herein are solutions for determining network support for UE policy sections management over EPS. In some aspects, a network entity may indicate to the UE at the time of attach procedure (e.g., as described in 3GPP TS 23.401) whether the network (i.e., EPS) supports UE policy sections management.

Beneficially, by identifying network support the UE policy section management, the UE may acquire relevant policy sections at an earlier timer, e.g., during registration with an EPS network, thereby improving communication quality and performance.

Aspects of the present disclosure are described in the context of a wireless communications system.

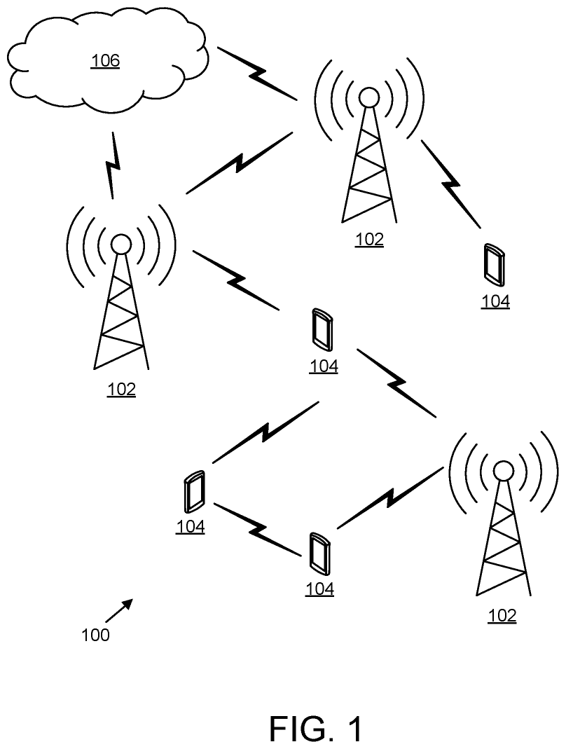

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (i.e., Wi-Fi), IEEE 802.16 (i.e., WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNB, a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink (SL). For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane (CP) entity that manages access and mobility (e.g., a MME, an access and mobility management functions (AMF)) and a user plane (UP) entity that routes packets or interconnects to external networks (e.g., a S-GW, a P-GW, or a user plane function (UPF)). In some implementations, the CP entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a synchronization signal block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB.

Note that with beam-based communication, each DL beam may be associated with a respective SSB. In 3GPP NR, the gNB may transmit the maximum 64 SSBs and the maximum 64 corresponding copies of physical downlink control channel (PDCCH) and/or physical downlink shared channel (PDSCH) for delivery of system information block #1 (SIB1) in high frequency bands (e.g., 28 GHz).

In the following, instead of “slot,” the terms “mini-slot,” “subslot,” or “aggregated slots” can also be used, wherein the notion of slot/mini-slot/sub-slot/aggregated slots can be described as defined in 3GPP technical specification (TS) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

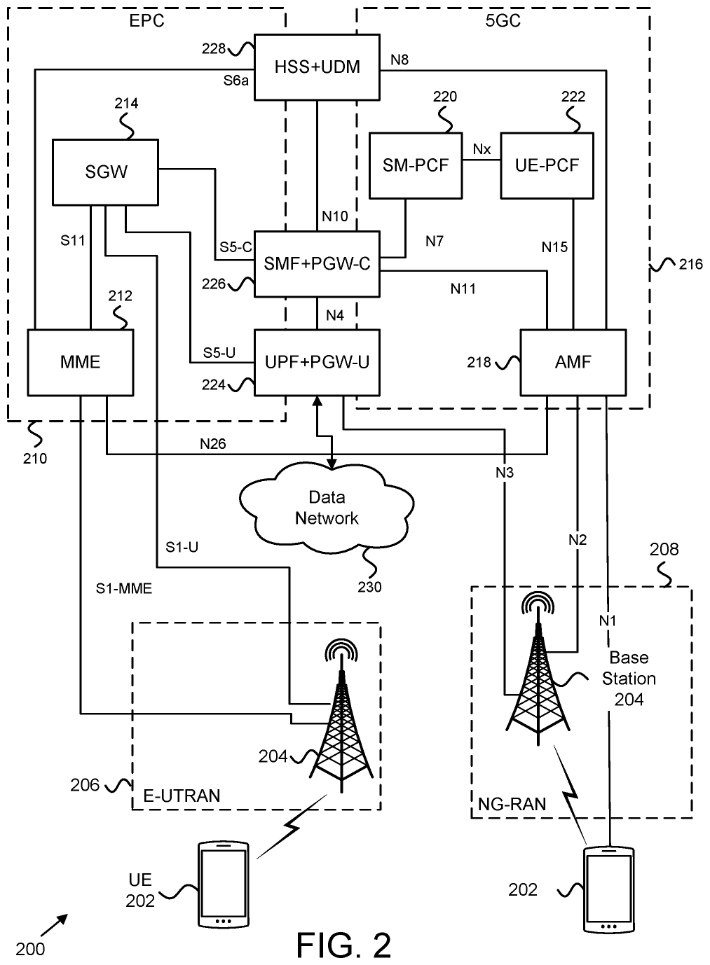

FIG. 2 is a block diagram illustrating one embodiment of a network architecture 200 for interworking between the 5GS (i.e., 5GC 216 and/or next generation RAN (NG-RAN) 208) and the EPS (i.e., EPC 210 and/or evolved universal terrestrial radio access network (E-UTRAN) 206). The network architecture 200 shows a variant of the wireless communication system 100 and comprises embodiments of the NE 102 and CN 106. The network architecture 200 includes a RAN comprising the E-UTRAN 206 with at least one 4G/LTE base station 204 (e.g., an eNB) and a NG-RAN 208 with at least one 5G/NR base station unit 204 (e.g., a gNB).

As depicted, the network architecture includes both 4G core network (i.e., EPC) entities and 5GC entities, and various interworking network functions for to support interworking between the user plane and certain control plane functions in the EPC 210 and the 5GC 216.

The EPC 210 includes an MME 212 and a S-GW 214 that are not shared with the 5GC 216. The 5GC 216 includes an AMF 218 and a split-architecture policy control function (PCF) comprising a SM-PCF 220 and a UE-PCF 222 that are not shared with the EPC 210. In some embodiments, the SM-PCF 220 provides policy control functionalities and information relating to session management, while the UE-PCF 222 manages UE management service-related policies, such as UE route selection policy (URSP) provisioning.

The network architecture 200 includes several shared/combined network entities that support interworking between the EPC 210 and the 5GC 216, including a combined UPF and P-GW-user-plane entity (UPF+PGW-U) 224, a combined SMF and P-GW-control-plane entity (SMF+PGW-C) 226, and a combined home subscriber server (HSS) and unified data management (UDM) entity (HSS+UDM) 228. Via the UPF+PGW-U 224, a subscriber (e.g., UE 202) may communicate with an application server, communication peer, or other endpoint in the data network 230.

Note that the notations “SMF+PGW-C” and “UPF+PGW-U” are used to show that the network functions used for, e.g., PDU Sessions in 5GC 216 and PDN Connections in EPC 210 are common, in case that internet protocol (IP) session continuity is required during transfer of PDU Sessions to PDN Connections and vice-versa. Although specific numbers and types of network functions are depicted in FIG. 2, one of skill in the art will recognize that any number and type of network functions may be included in the mobile core network.

FIG. 2 illustrates an example of various network interfaces (also referred to as reference points) that facilitate communication with the CN elements. For example, a UE 202 may communicate with a base station 204 (e.g., RAN node) via the Uu interface and communicate with the AMF 218 via the N1 interface, while the base station 204 may communicate with the AMF 218 via the N2 interface and with the UPF+PGW-U 224 via the N3 interface. As another example, a base station 204 may communicate with the MME 212 via the S1-MME interface and with the S-GW 214 via the S1-U interface. Other network interfaces are depicted, including, but not limited to, a N4 interface between the UPF+PGW-U 224 and the SMF+PGW-C 226, a N7 interface between the SMF+PGW-C 226 and the SM-PCF 220, a Nx interface between the SM-PCF 220 and the UE-PCF 222, a N8 interface between the AMF 218 and the HSS+UDM 228, a N10 interface between the SMF+PGW-C 226 and the HSS+UDM 228, a N11 interface between the AMF 218 and the SMF+PGW-C 226, a N15 interface between the AMF 218 and the UE-PCF 222, a N26 interface between the AMF 218 and the MME 212 (e.g., supporting inter-system handover from the 5GC 216 to EPC 210, or vice versa), a S5-U interface between the S-GW 214 and the UPF+PGW-U 224, a S5-C interface between the S-GW 214 and the SMF+PGW-C 226, a S6a interface between the MME 212 and the HSS+UDM 228, and the S11 interface between the MME 212 and the S-GW 214.

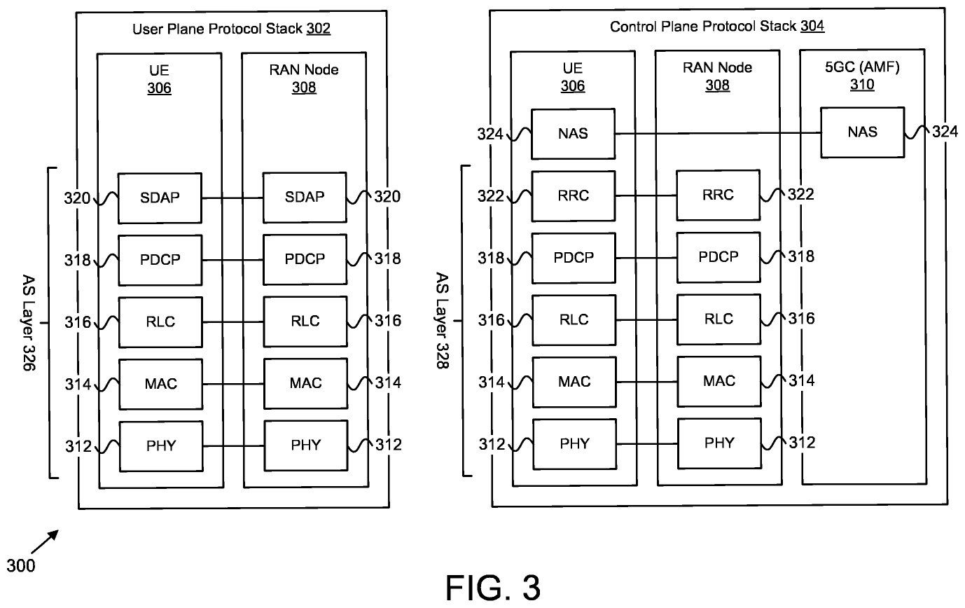

FIG. 3 illustrates an example of a protocol stack 300, in accordance with aspects of the present disclosure. In certain embodiments, the protocol stack 300 is an NR protocol stack for communication between the UE and the mobile network. While FIG. 3 shows a UE 306, a RAN node 308, and a 5G core network (5GC) 310 (e.g., comprising at least an AMF), these are representative of a set of UEs 104 interacting with an NE 102 (e.g., base station) and a CN 106.

As depicted, the protocol stack 300 comprises a UP protocol stack 302 and a CP protocol stack 304. The UP protocol stack 302 includes a physical (PHY) layer 312, a MAC sublayer 314, a radio link control (RLC) sublayer 316, a packet data convergence protocol (PDCP) sublayer 318, and a service data adaptation protocol (SDAP) layer 320. The CP protocol stack 304 includes a PHY layer 312, a MAC sublayer 314, a RLC sublayer 316, and a PDCP sublayer 318. The CP protocol stack 304 also includes a radio resource control (RRC) layer 322 and a non-access stratum (NAS) layer 324.

The AS layer 326 (also referred to as “AS protocol stack”) for the UP protocol stack 302 consists of at least SDAP, PDCP, RLC and MAC sublayers, and the physical layer. The AS layer 328 for the CP protocol stack 304 consists of at least RRC, PDCP, RLC and MAC sublayers, and the physical layer. The layer-1 (L1) includes the PHY layer 312. The layer-2 (L2) is split into the SDAP sublayer 320, PDCP sublayer 318, RLC sublayer 316, and MAC sublayer 314. The layer-3 (L3) includes the RRC layer 322 and the NAS layer 324 for the CP and includes, e.g., an internet protocol (IP) layer and/or PDU Layer (not depicted) for the UP. L1 and L2 are referred to as “lower layers,” while L3 and above (e.g., transport layer, application layer) are referred to as “higher layers” or “upper layers.”

The PHY layer 312 offers transport channels to the MAC sublayer 314. The PHY layer 312 may perform a beam failure detection procedure using energy detection thresholds, as described herein. In certain embodiments, the PHY layer 312 may send an indication of beam failure to a MAC entity at the MAC sublayer 314. The MAC sublayer 314 offers logical channels to the RLC sublayer 316. The RLC sublayer 316 offers RLC channels to the PDCP sublayer 318. The PDCP sublayer 318 offers radio bearers to the SDAP sublayer 320 and/or RRC layer 322. The SDAP sublayer 320 offers QoS flows to the core network (e.g., 5GC). The RRC layer 322 provides for the addition, modification, and release of carrier aggregation and/or dual connectivity. The RRC layer 322 also manages the establishment, configuration, maintenance, and release of signaling radio bearers (SRBs) and data radio bearers (DRBs).

The NAS layer 324 is between the UE 306 and an AMF in the 5GC 310. NAS messages are passed transparently through the RAN. The NAS layer 324 is used to manage the establishment of communication sessions and for maintaining continuous communications with the UE 306 as it moves between different cells of the RAN. In contrast, the AS layers 326 and 328 are between the UE 306 and the RAN (i.e., RAN node 308) and carry information over the wireless portion of the network. While not depicted in FIG. 3, the IP layer exists above the NAS layer 324, a transport layer exists above the IP layer, and an application layer exists above the transport layer.

The MAC sublayer 314 is the lowest sublayer in the L2 architecture of the protocol stack 300. Its connection to the PHY layer 312 below is through transport channels, and the connection to the RLC sublayer 316 above is through logical channels. The MAC sublayer 314 therefore performs multiplexing and demultiplexing between logical channels and transport channels: the MAC sublayer 314 in the transmitting side constructs MAC PDUs (also known as transport blocks (TBs)) from MAC service data units (SDUs) received through logical channels, and the MAC sublayer 314 in the receiving side recovers MAC SDUs from MAC PDUs received through transport channels.

The MAC sublayer 314 provides a data transfer service for the RLC sublayer 316 through logical channels, which are either control logical channels which carry control data (e.g., RRC signaling) or traffic logical channels which carry UP data. On the other hand, the data from the MAC sublayer 314 is exchanged with the PHY layer 312 through transport channels, which are classified as uplink (UL) or DL. Data is multiplexed into transport channels depending on how it is transmitted over the air.

The PHY layer 312 is responsible for the actual transmission of data and control information via the air interface, i.e., the PHY layer 312 carries all information from the MAC transport channels over the air interface on the transmission side. Some of the important functions performed by the PHY layer 312 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 322. The PHY layer 312 performs transmissions based on transmission parameters, such as the modulation scheme, the coding rate (i.e., the modulation and coding scheme (MCS)), the number of physical resource blocks (PRBs), etc.

Note that an LTE protocol stack may comprise a similar structure to the protocol stack 300, with the differences that the LTE protocol stack lacks the SDAP sublayer 320 in the AS layer 326, that an EPC replaces the 5GC 310, and that the NAS layer 324 is between the UE 306 and an MME in the EPC. Also note that the present disclosure distinguishes between a protocol layer (such as the aforementioned PHY layer 312, MAC sublayer 314, RLC sublayer 316, PDCP sublayer 318, SDAP sublayer 320, RRC layer 322 and NAS layer 324) and a transmission layer in multiple-input multiple-output (MIMO) communication (also referred to as a “MIMO layer” or a “data stream”).

The policy management for access and mobility comprises policy control for session management and service data flow which involves QoS control, gating control etc. The network can provide the URSP which is a set of rules including traffic descriptors and route selection descriptors for the UE to establish the PDU session in the 5GS.

For the network to provide the UE the URSP, the UE performs the UE-initiated UE state indication procedure (e.g., as described in 3GPP TS 24.501) which is performed at the time the UE registers to the 5GS at the time of initial registration or at the time of inter-system change, e.g., from S1 mode to N1 mode.

To perform the UE-initiated UE State Indication procedure, the UE provides a number of IEs to the PCF so that the PCF can arrange a number of URSP rules for the UE. According to 3GPP TS 24.501 (v18.2.1), the IEs that the UE provides in the UE State Indication message are: a) the UE policy section identifier (UPSI) list IE which contains a number of UE policy section codes (UPSC) assigned by the registered public land mobile network (RPLMN); b) the UE policy classmark IE comprising information about policy aspect of the UE; and c) the UE operating system (OS) identifiers (IDs) IE that indicates what OSs the UE supports. The length of the UE State Indication message can therefore be up to two octets or up to 65K octets.

3GPP has recently introduced the UE-initiated UE State Indication procedure for EPS. For that purpose, the working item enhanced UE policy (eUEPO) allows the UE receiving UE policy sections when the UE registers to the EPS network. The network architecture with the capability to transmit policy sections to the UE is according to FIG. 1B. The UE, at the time of attach to the EPS, requests establishment of a PDN connectivity and by using an ePCO IE transmits the UE State Indication message to the SMF+PGW-C which will later be forwarded to SM-PCF to establish a UE policy associations with UE-PCF in order to provide the UE policy sections.

3GPP TS 24.008 and 3GPP TS 24.008 define the ePCO comprising the container with container ID 0056H carrying the UE policy container with the length of two octets for both directions a) from the UE to the PCF where the UE State Indication message is included in the UE policy container; and b) from the network to the UE where the UE policy section management list or any other information is carried from the PCF to the UE.

If the UE supports the ePCO IE, this new ePCO is used by the UE to trigger the establishment of the UE policy association and thereby arrangement of the UE policy section management list or any other information that should be transmitted by the PCF to the UE. The procedure for including the ePCO with the UE policy container IE in the attach procedure is according to that the UE: a) includes the new ePCO IE comprising the UE State Indication message within the PDN Connectivity Request message; b) constructs the Attach Request message comprising the EPS session management (ESM) message containing IE, containing the PDN Connectivity Request message; and c) sets the ePCO bit to “extended protocol configuration options supported” in the UE network capability IE of the Attach Request message.

The UE then transmits the Attach Request message towards the network. However, for this procedure to work, it is required that the network point of the contact for this request which is the MME supports the ePCO IE. Since in early versions of the EPS, the Protocol configuration options IE was introduced, it is not clear that the network entities such as MME or S-GW support the ePCO IE. If the MME does not support the ePCO IE, the MME will simply drop the ePCO comprising the UE State Indication message and therefore no UE policy association will be established between the SM-PCF and the UE-PCF and as the consequence the UE will not receive any UE policy sections management list or any other information that it should receive from the PCF.

Described herein are procedures and signaling between a UE and EPS entities that support techniques for determining network support for UE policy sections management over the EPS. Since the procedure for the UE-initiated UE State Indication procedure in the EPS network is originally for the 5GS network—which always supports the UE policy sections management—there is not any indication in the conventional response of the EPS attach request that the UE can find out whether the EPS network supports for UE policy sections management over the EPS. At the time of UE attach to the EPS, even if the network and the UE support ePCO end-to-end, the UE can only find out if the UE at some point receives the UE policy sections from the network.

Beneficially, the solutions described herein provide a capability for the network to indicate to the UE at the time of attach procedure whether the network supports the UE policy section managements.

As used herein, the UE policy consists of: 1) UE Access Network discovery and selection policies (ANDSP); 2) UE Route Selection Policy (URSP); 3) UE Vehicle-to-Everything Policy (V2XP); and 4) UE 5G Proximity based Services Policy (ProSeP). The UE Policy is transferred to the UE using a UE policy delivery protocol.

The ANDSP is used by the UE for selecting non-3GPP accesses networks. The ANDSP may contain one or more WLAN Selection Policy (WLANSP) rules and/or may contain Non-3GPP access network (N3AN) node selection information and configuration information. Examples of the encoding of ANDSP are defined in 3GPP TS 24.526.

The URSP is used by the UE to determine how to route outgoing traffic. Traffic can be routed to an established PDU Session, offloaded to non-3GPP access outside a PDU Session, can be routed via a ProSe Layer-3 UE-to-Network Relay outside a PDU session or trigger the establishment of a new PDU Session. Examples of the encoding of URSP are defined in 3GPP TS 24.526.

The UE V2XP provides configuration information to the UE for V2X communications over PC5 reference point or over Uu reference point or both. Examples of the encoding of V2XP are defined in 3GPP TS 24.588.

The UE 5G ProSeP provides configuration information to the UE for 5G ProSe direct discovery, 5G ProSe direct communications, 5G ProSe UE-to-network relay and/or 5G ProSe usage reporting configuration and rules.

Regarding UE policy delivery, the PCF (e.g., visiting PCF (V-PCF) or home PCF (H-PCF) may deliver the UE policy to the UE in one or multiple “MANAGE UE POLICY COMMAND” messages. For the purpose of such fragmented delivery and subsequent partial updates of UE policies, the UE policy is divided into policy sections.

The UE policy sections may be predefined in the PCF, may be retrieved by the PCF from the UDR, or may be dynamically generated by the PCF. The PCF may combine several policy sections into one “MANAGE UE POLICY COMMAND” message, if the predefined size limit is observed.

The following rules apply to policy sections: 1) The size must be below the predefined size limit; 2) The policy section only contains complete URSP rule(s), WLANSP rule(s), N3AN node configuration information, V2XP and/or ProSeP info content, but no fractions of such rules, configuration information, or info contents; 3) To ease a subsequent partial update of UE policies, policy sections should only contain a small number of policies, e.g. URSP rule(s), and/or WLANSP rule(s); and 4) The entire content of a policy section is to be provided by a single PLMN.

Each UE policy section is identified by a UE policy section identifier (UPSI). The UPSI is composed of two parts: 1) a PLMN ID part containing the PLMN ID of the PLMN or SNPN of the PCF which provides the UE policies; and 2) a UE policy section code (UPSC) containing a unique value within the PLMN or SNPN selected by the PCF.

A PCF shall only determine policy sections of its own PLMN. However, a V-PCF may forward UE policy sections received from the H-PCF to the UE. The PCF provides an UPSI when providing a new UE policy section and may then identify that policy section using that UPSI when requesting that that UE policy section is modified or deleted.

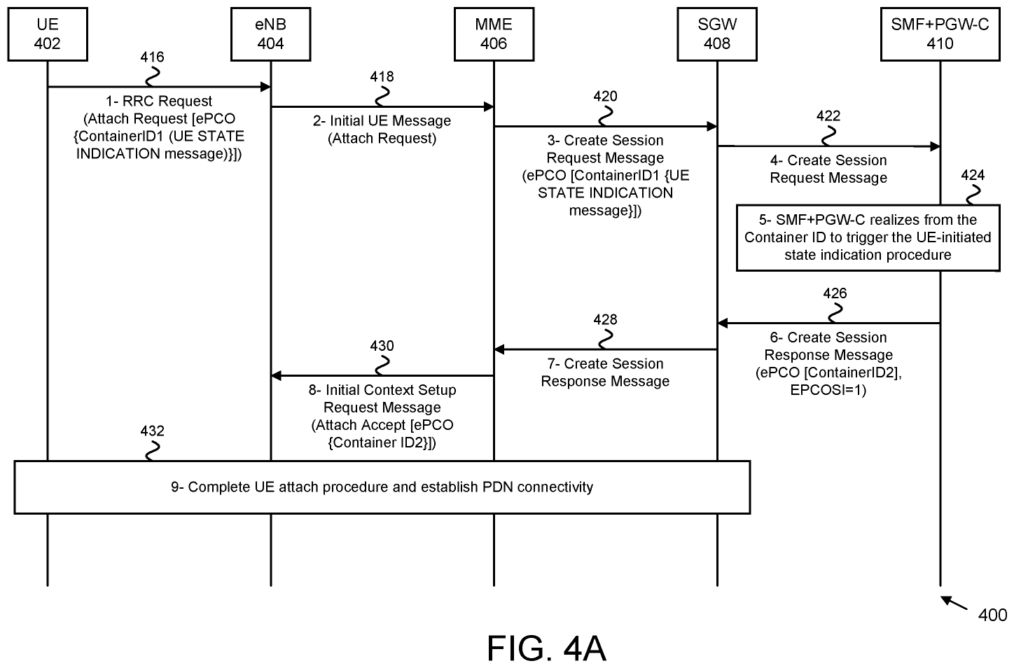

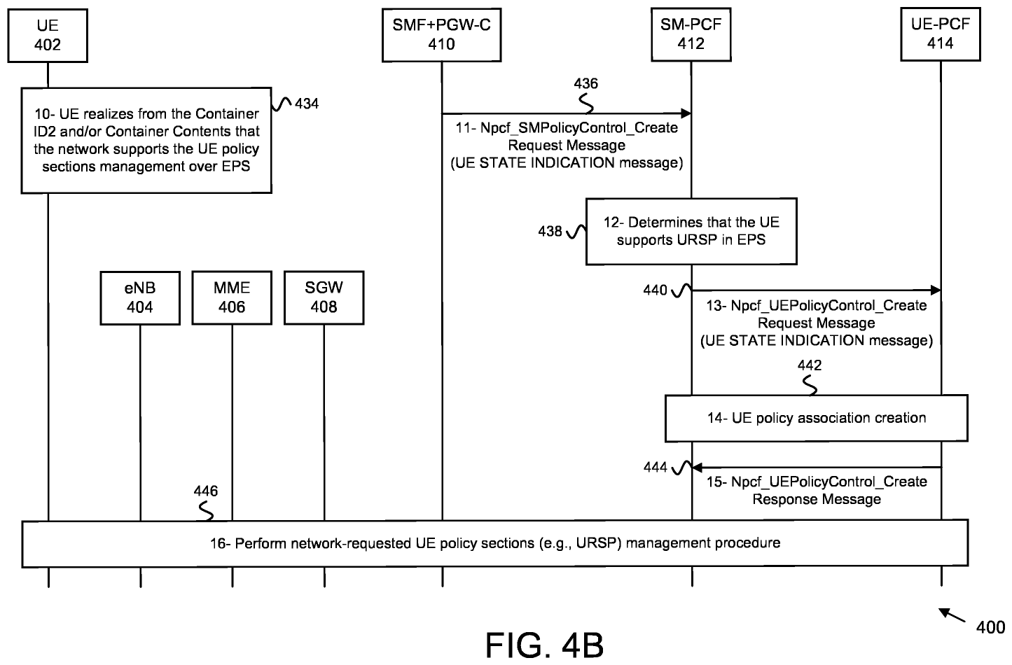

FIGS. 4A-4B illustrate an exemplary procedure 400 for determining network support for UE policy sections management over EPS, in accordance with aspects of the present disclosure. The procedure 400 involves a UE 402, an eNB 404, an MME 406, a S-GW 408, a SMF+PGW-C 410, a SM-PCF 412 and a UE-PCF 414. The UE 402 may be one embodiment of the UE 104, the UE 202, and/or the UE 306. The eNB 404 may be one embodiment of the NE 102, the base station 204, and/or the RAN node 308. The MME 406 may be one embodiment of the MME 212. The S-GW 408 may be one embodiment of the S-GW 214. The SMF+PGW-C 410 may be one embodiment of the SMF+PGW-C 226. The SM-PCF 412 may be one embodiment of the SM-PCF 220. The UE-PCF 414 may be one embodiment of the UE-PCF 222. The procedure 400 depicts/describes an example of how the UE 402 can receive an indication that there is network support for UE policy sections management over EPS.

Beginning at FIG. 4A, at Step 1, the UE 402 initiates an initial attach procedure with PDN connectivity by transmitting an RRC request to the eNB 404 (see signaling 416). Here, the RRC request message contains an attach request (e.g., Attach Request message). The attach request includes an ePCO IE comprising the container with container ID 0056H (denoted in FIG. 4A as “Container ID1”) to carry the UE policy container which includes a UE State Indication message. Moreover, the UE 402 performs a UE-initiated UE state indication procedure by including the UE State Indication message comprising: a) the UPSI list; b) UE policy classmark including the UE's support for ANDSP; and c) possibly the supporting OS IDs.

If the UE 402 is within the inter-system change from the 5GS to EPS and transferring one or more PDU sessions, then the UE 402 also includes the identity of any PDU session which is to be transferred from the 5GS to EPS in the ePCO. Note that ePCO IEs are used to transfer parameters between the UE 402 and the P-GW (e.g., the “PGW-C” part of the SMF+PGW-C 410), and are sent transparently through the MME 406 and the S-GW 408.

The UE 402 initiates the Attach procedure by the transmission, to the eNB 404, of an Attach Request message together with RRC parameters indicating the Selected Network and the old globally unique MME identifier (GUMMEI). The parameters included in the Attach Request message may comprise one or more of the following: international mobile subscriber identity (IMSI) or old globally unique temporary identifier (GUTI), Old GUTI type, last visited tracking area identity (TAI) (if available), UE core network capability, UE specific discontinuous reception (DRX) parameters, extended idle mode DRX parameters, UE paging probability information, Attach type, an ESM message container (e.g., comprising request type, PDN type, protocol configuration options (PCO), ciphered options transfer flag, header compression configuration), KSIASME, NAS sequence number, NAS-MAC, additional GUTI, Packet Temporary Mobile Subscriber Identity (P-TMSI) signature, Voice domain preference and UE's usage setting, Preferred Network behavior, MS Network Capability, Support for restriction of use of Enhanced Coverage, UE has UE Radio Capability ID assigned for the selected PLMN, Requested IMSI Offset. These parameters and conditions for their inclusion in the Attach Request are described in detail in 3GPP TS 23.402 (v18.1.0), clause 5.3.2.1. In the RRC connection establishment signaling associated with the Attach Request, the UE 402 indicates its support of the Consumer Internet-of-Things (CIoT) EPS Optimizations, relevant for MME selection.

The UE 402 constructs the Attach Request message comprising the ESM message container IE, containing the PDN Connectivity Request message. The UE 402 includes the ePCO IE comprising the UE State Indication message, within the PDN Connectivity Request message. The UE 402 also sets the ePCO bit to “ePCO supported” in the UE network capability IE of the Attach Request message. The UE 402 transmits the Attach Request message towards the network.

At Step 2, the eNB 404 selects an MME 406 by deriving the MME address from the RRC parameters carrying the old GUMMEI, the indicated Selected Network and the RAT (e.g., narrowband-IoT or wideband (WB) E-UTRAN). If the MME 406 is not already associated with the eNB 404 (or if the old GUMMEI is not available), then the eNB 404 selects the MME 406 as described in 3GPP TS 23.402, Clause 4.3.8.3 on “MME selection function”. Additionally, the eNB 404 forwards the Attach Request message (i.e., comprising the ePCO IE comprising the UE State Indication message) in an S1-MME control message (i.e., Initial UE message) to the MME 406 (see signaling 418). In various embodiments, the initial UE message also includes one or more of the following parameters: the selected network, the closed subscriber group (CSG) access mode, the CSG ID, the local gateway (L-GW) address, and/or the combined TAI and E-UTRAN cell global identifier (ECGI) of the cell from where the eNB 404 it received the RRC request message. These parameters and conditions for their inclusion in the Initial UE message are described in detail in 3GPP TS 23.402 (v18.1.0), clause 5.3.2.1.

At Step 3, the MME 406 selects an S-GW 408 for the uplink traffic on the S1-U reference point and exchanges Create Session request and Create Session response messages. In various embodiments, the MME 406 selects the S-GW 408 based on network topology, i.e., the selected S-GW 408 serves the UE's location and for overlapping S-GW service areas, the selection may prefer S-GWs with service areas that reduce the probability of changing the S-GW.

In the procedure 400, it is assumed that the MME 406 supports ePCO, therefore when constructing the Create Session request message, the MME 406 includes the ePCO comprising the UE State Indication message. Consequently, the MME 406 sets the extended PCO support indication (EPCOSI) to ‘1’ on the S11 interface to inform the S-GW 408 about its ePCO support. The MME 406 transmits the Create Session request message to the S-GW 408 (see signaling 420). In various embodiments, the Create Session request message is constructed according to 3GPP TS 29.274.

At Step 4, the S-GW 408 creates a new entry in its EPS bearer context table and sends a Create Session request message to the SMF+PGW-C 410 (see signaling 422). Again, the Create Session request message comprises the ePCO IE containing UE State Indication message. In addition, this Create Session request message may include one or more of the following parameters: access point name (APN), S-GW address, PDN address, subscribed APN, and PCO. The S-GW 408 transmits the Create Session request message towards the SMF+PGW-C address received in the previous step.

At Step 5, upon receipt of the Create Session request message, the SMF+PGW-C 410 realizes based on the ePCO IE with the container ID 0056H indicating that the container comprises the UE State Indication message (see block 424). Therefore, the SMF+PGW-C 410 recognizes that the UE 402 supports the UE policy sections management in the EPS. In the procedure 400, it is assumed that the SMF+PGW-C 410 supports the UE policy sections management in the EPS.

At Step 6, the SMF+PGW-C 410 constructs a create session response message comprising the ePCO IE with a new container ID corresponding to an indication that the SMF+PGW-C 410 supports the UE policy sections management over the EPS and sets the EPCOSI value to 1. In one embodiment, only the new container ID is needed to indicate that the SMF+PGW-C 410 supports the UE policy sections management in the EPS (i.e., the container ID itself is the indication that the SMF+PGW-C 410 supports the UE policy sections management over the EPS). In another embodiment, the contents of the container (i.e., corresponding to the new container ID) may indicate that the SMF+PGW-C 410 supports the UE policy sections management in the EPS. The SMF+PGW-C 410 transmits the create session response message towards the S-GW 408 (see signaling 426).

At Step 7, the S-GW 408 forwards the create session response message towards the MME 406 (see signaling 428). Here, the create session response message comprises the ePCO with the container ID and/or the container contents indicating that the SMF+PGW-C 410 supports the UE policy sections management in the EPS. The EPCOSI value is also set to 1.

At Step 8, upon receipt of the create session response message comprising the ePCO with the container ID and/or the container contents indicating that the SMF+PGW-C 410 supports the UE policy sections management in the EPS, the MME 406 creates an Attach Accept message comprising the ESM message container IE and sets the ePCO bit to “extended protocol configuration options supported”. Here, the ESM message container IE comprises the Activate Default EPS Bearer Context Request message (or Activate Dedicated EPS Bearer Context Request message) where the Activate Default Eps Bearer Context Request message (or Activate Dedicated EPS Bearer Context Request message) includes the ePCO IE with the container with the new container ID indicating that the SMF+PGW-C 410 supports the UE policy sections management over the EPS.

The MME 406 transmits the Attach Accept message towards the UE 402 in the initial context setup request message (see signaling 430) and receives the initial context setup response message (not depicted in FIG. 4A).

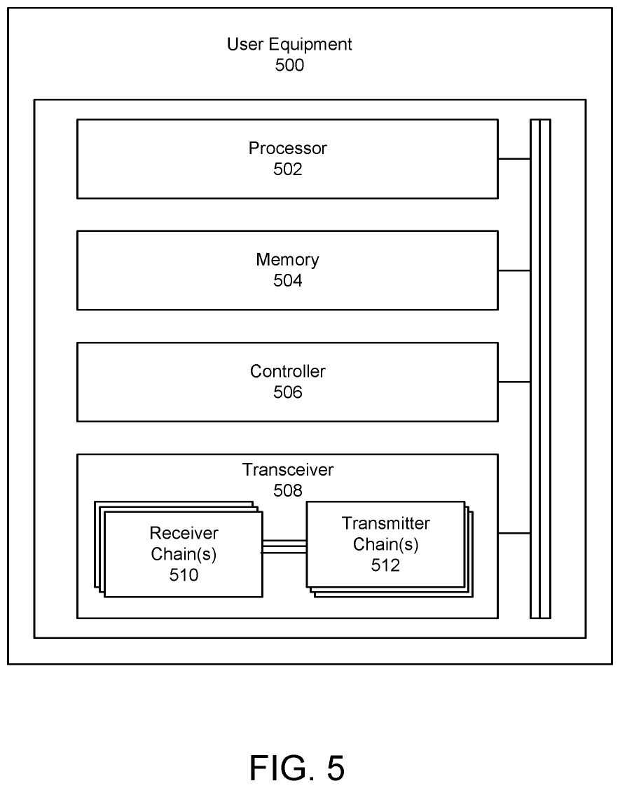

At Step 9, the UE 402 completes its attachment to the EPS and establishes PDN connectivity (see block 432). Here, the UE 402 may exchange RRC connection reconfiguration messages with the eNB 404, the eNB 404 may send an Attach complete message to the MME 406, and the MME 406 may exchange Modify Bearer messages with the S-GW 408. In various embodiments, the completion of the UE's attachment to the EPS by establishing PDN connectivity is as described in steps 18 through 24 of FIG. 5.3.2.1-1 in 3GPP TS 23.402.

Continuing at FIG. 4B, at Step 10, upon receipt of the ePCO IE with the container with the new container ID indicating the SMF+PGW-C support for the UE policy sections management over the EPS, the UE 402 is aware that the SMF+PGW-C 410 supports the UE policy sections management in the EPS and that the UE 402 may receive UE policy sections over the EPS (see block 434).

Note that Steps 11-15 may occur at any time after Step 5 is completed.

At Step 11, upon receipt of the Create Session request message and realizing that the included ePCO IE comprising the UE State Indication message, the SMF+PGW-C 410 determines that the UE 402 supports the URSP provisioning in the EPS and forwards the UE State Indication message towards the SM-PCF 412 (see signaling 436). In some embodiments, the SMF+PGW-C 410 invokes a Npcf_SMPolicyControl_Create Service Operation and uses an hypertext transfer protocol (HTTP) POST request to forward the UE State Indication message to the SM-PCF 412, e.g., where the UE State Indication message is contained in the payload body of an HTTP POST request according to 3GPP TS 29.512.

At Step 12, based on the information provided by the SMF+PGW-C 410, the SM-PCF 412 determines that the UE 402 supports UE policy sections management list in the EPS (see block 438). In some embodiments, the SM-PCF 412 may check the UE's support for the UE policy section management list, including receiving the URSP, by examining the UE context policy control subscription information in the UDR. Based on the determination, the SM-PCF 412 decides to establish a UE policy association towards the UE-PCF 414.

At Step 13, the SM-PCF 412 selects the UE-PCF 414 with which to establish the UE policy association in the EPS. The SM-PCF 412 requests a new UE policy association by transmitting the UE State Indication message to the UE-PCF (see signaling 440). In some embodiments, the SM-PCF 412 invokes a Npcf_UEPolicyControl_Create Service Operation and uses an HTTP POST request to forward the UE State Indication message to the UE-PCF 414, e.g., where the UE State Indication message is contained in the payload body of an HTTP POST request message according to 3GPP TS 29.525.

At Step 14, the SM-PCF 412 and UE-PCF 414 create the new UE policy association (see block 442). In some embodiments, the creation of the UE policy association is performed according to Clause 4.2.2 of 3GPP TS 29.525.

At Step 15, the UE-PCF 414 returns a response message to the SM-PCF 412 (see signaling 444). Here, the UE-PCF 414 may use the Npcf_UEPolicyControl_Create Service Operation and send an HTTP “201 Created” response message to the SM-PCF 412, according to 3GPP TS 29.525.

At Step 16, after the UE policy association is established, the UE-PCF 414 may determine to transmit the new policy sections management including the URSP towards the UE 402 by performing a network-requested UE policy sections management procedure (see block 446). In some embodiments, the network-requested UE policy management procedure invokes the UE policy delivery protocol, e.g., as defined in Annex D of 3GPP TS 24.501. The procedure 400 ends.

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). For example, the processor 502 may support wireless communication at the UE 500 in accordance with examples as disclosed herein.

The UE 500 may be configured to support a means for transmitting, e.g., to a network node in an EPS, a request message comprising a first ePCO IE. In some embodiments, the request message comprises a UE State Indication message, wherein the UE State Indication message comprises the first ePCO IE.

In some embodiments, the request message comprises an attach request message, and wherein the response message comprises an attach accept message. In some embodiments, the request message comprises a PDN connectivity request message, where the response message comprises an activate default EPS bearer context request message or an activate dedicated EPS bearer context request message.

In some embodiments, a payload of the first ePCO IE comprises a container having a particular container ID, wherein the particular container ID identifies that the container comprises the UE State Indication message, and wherein the particular container ID and/or contents of the container indicate that the UE supports the UE policy sections management.

The UE 500 may be configured to support a means for receiving, from the network node, a response message comprising a second ePCO IE. In some embodiments, the network node comprises a combined SMF and a PGW-C.

The UE 500 may be configured to support a means for determining that the EPS supports UE policy sections management based on the second ePCO IE. In some embodiments, a payload of the second ePCO IE comprises a container, and wherein contents of the container indicate that the network node supports the UE policy sections management in the EPS.

In some embodiments, a payload of the first ePCO IE comprises a first container having a first container ID, and wherein a payload of the second ePCO IE comprises a second container having a second container ID different than the first. In certain embodiments, the second container ID indicates that the network node supports the UE policy sections management in the EPS.

In some embodiments, the second ePCO IE comprises an indication that the network node supports URSP provisioning over the EPS. In certain embodiments, a payload of the second ePCO IE comprises a container having a container ID, and wherein the container ID and/or contents of the container indicate that the network node supports the URSP provisioning over the EPS.

The UE 500 may be configured to support a means for performing a network-requested UE policy management procedure based on the EPS supporting the UE policy sections management.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems (OSes). In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the receiving signal and obtain the transmitted data by reversing the modulation technique applied during transmission of the signal. The receiver chain 510 may include at least one decoder for decoding and processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

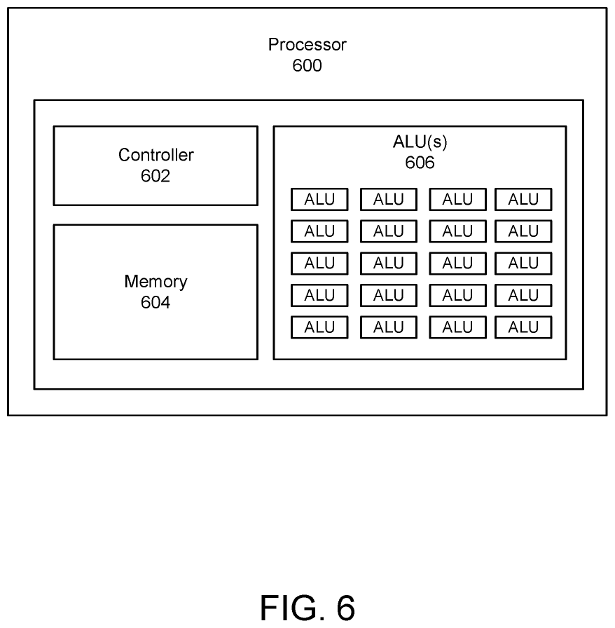

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may perform one or more of the UE functions described herein. The processor 600 may be configured to or operable to support a means for transmitting, e.g., to a network node in an EPS, a request message comprising a first ePCO IE. In some embodiments, the request message comprises a UE State Indication message, wherein the UE State Indication message comprises the first ePCO IE.

In some embodiments, the request message comprises an attach request message, and wherein the response message comprises an attach accept message. In some embodiments, the request message comprises a PDN connectivity request message, where the response message comprises an activate default EPS bearer context request message or an activate dedicated EPS bearer context request message.

In some embodiments, a payload of the first ePCO IE comprises a container having a particular container ID, wherein the particular container ID identifies that the container comprises the UE State Indication message, and wherein the particular container ID and/or contents of the container indicate that the UE supports the UE policy sections management.

The processor 600 may be configured to or operable to support a means for receiving, from the network node, a response message comprising a second ePCO IE. In some embodiments, the network node comprises a combined SMF and a PGW-C.

The processor 600 may be configured to or operable to support a means for determining that the EPS supports UE policy sections management based on the second ePCO IE. In some embodiments, a payload of the second ePCO IE comprises a container, and wherein contents of the container indicate that the network node supports the UE policy sections management in the EPS.

In some embodiments, a payload of the first ePCO IE comprises a first container having a first container ID, and wherein a payload of the second ePCO IE comprises a second container having a second container ID different than the first. In certain embodiments, the second container ID indicates that the network node supports the UE policy sections management in the EPS.

In some embodiments, the second ePCO IE comprises an indication that the network node supports URSP provisioning over the EPS. In certain embodiments, a payload of the second ePCO IE comprises a container having a container ID, and wherein the container ID and/or contents of the container indicate that the network node supports the URSP provisioning over the EPS.

The processor 600 may be configured to or operable to support a means for performing a network-requested UE policy management procedure based on the EPS supporting the UE policy sections management.

In further embodiments, the processor 600 may perform one or more of the SMF+PGW-C functions described herein. For example, the processor 600 may be embodied within a network node in an EPS, where the network node is configured to or operable to support a combined SMF and a PGW-C. The processor 600 may be configured to or operable to support a means for receiving, from a UE, a request message comprising a first ePCO IE. In some embodiments, the request message comprises a UE State Indication message, wherein the UE State Indication message comprises the first ePCO IE. The processor 600 may be configured to or operable to support a means for forwarding the UE State Indication message to a SM-PCF.

The processor 600 may be configured to or operable to support a means for determining that the UE supports UE policy sections management based on the first ePCO IE. In some embodiments, a payload of the first ePCO IE comprises a container having a particular container ID, wherein the particular container ID identifies that the container comprises the UE State Indication message, and wherein the particular container ID and/or contents of the container indicate that the UE supports the UE policy sections management.

The processor 600 may be configured to or operable to support a means for transmitting, to the UE, a response message comprising a second ePCO IE. In some embodiments, the request message comprises a Create Session request message, and the response message comprises a Create Session response message.

In some embodiments, the second ePCO IE comprises an indication that the apparatus supports URSP provisioning over the EPS. In certain embodiments, a payload of the second ePCO IE comprises a container having a ID, and wherein the container ID and/or contents of the container indicate that the processor 600 supports the URSP provisioning over the EPS.

In some embodiments, a payload of the first ePCO IE comprises a first container having a first container ID, and a payload of the second ePCO IE comprises a second container having a second container ID different than the first. In certain embodiments, the second container ID indicates that the processor 600 supports the UE policy sections management in the EPS.

In some embodiments, a payload of the second ePCO IE comprises a container, where contents of the container indicate that the apparatus supports the UE policy sections management in the EPS.

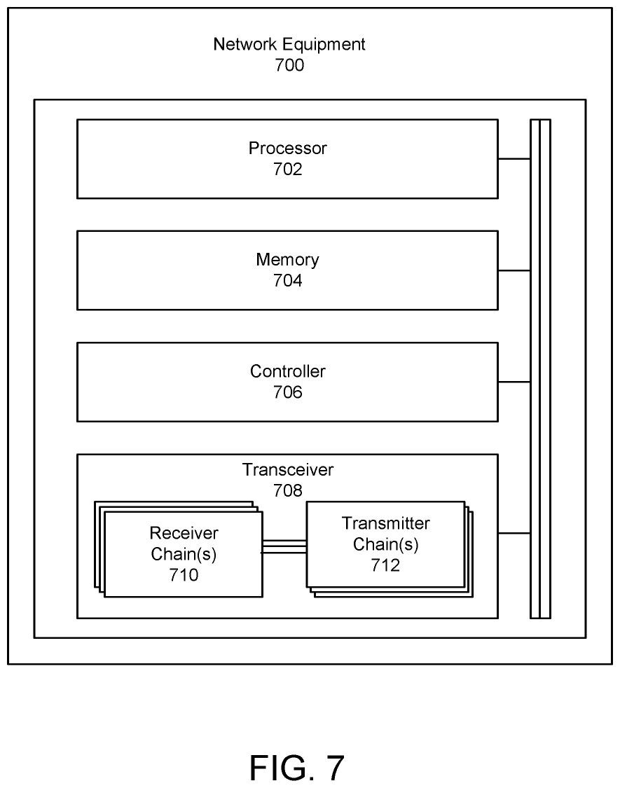

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the SMF+PGW-C functions described herein (e.g., executing, by the processor 702, instructions stored in the memory 704). For example, the processor 702 may support wireless communication at the NE 700 in accordance with examples as disclosed herein.

The NE 700 may be configured to support a means for receiving, from a UE, a request message comprising a first ePCO IE. In some embodiments, the request message comprises a UE State Indication message, wherein the UE State Indication message comprises the first ePCO IE. The NE 700 may be configured to support a means for forwarding the UE State Indication message to a SM-PCF.

The NE 700 may be configured to support a means for determining that the UE supports UE policy sections management based on the first ePCO IE. In some embodiments, a payload of the first ePCO IE comprises a container having a particular container ID, wherein the particular container ID identifies that the container comprises the UE State Indication message, and wherein the particular container ID and/or contents of the container indicate that the UE supports the UE policy sections management.

The NE 700 may be configured to support a means for transmitting, to the UE, a response message comprising a second ePCO IE. In some embodiments, the request message comprises a Create Session request message, and the response message comprises a Create Session response message.

In some embodiments, the second ePCO IE comprises an indication that the apparatus supports URSP provisioning over the EPS. In certain embodiments, a payload of the second ePCO IE comprises a container having a ID, and wherein the container ID and/or contents of the container indicate that the NE 700 supports the URSP provisioning over the EPS.

In some embodiments, a payload of the first ePCO IE comprises a first container having a first container ID, and a payload of the second ePCO IE comprises a second container having a second container ID different than the first. In certain embodiments, the second container ID indicates that the NE 700 supports the UE policy sections management in the EPS.

In some embodiments, a payload of the second ePCO IE comprises a container, where contents of the container indicate that the apparatus supports the UE policy sections management in the EPS.

The controller 706 may manage input and output signals for the NE 700. The controller 706 may also manage peripherals not integrated into the NE 700. In some implementations, the controller 706 may utilize an OS such as iOS®, ANDROID®, WINDOWS®, or other OSes. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a LNA) configured to amplify the received signal. The receiver chain 710 may include at least one demodulator configured to demodulate the receiving signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

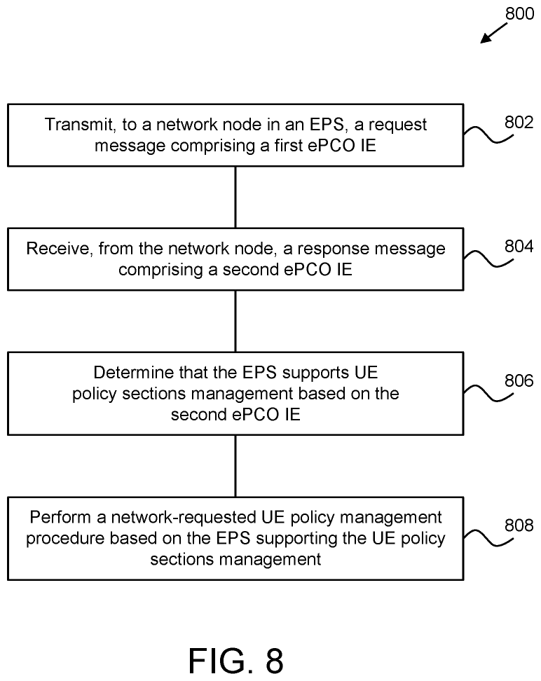

FIG. 8 illustrates a flowchart of a method 800 in accordance with aspects of the present disclosure. The operations of the method 800 may be implemented by a UE as described herein. In some implementations, the UE may execute a set of instructions to control the function elements of the UE to perform the described functions.

At Step 802, the method 800 may include transmitting, to a network node in an EPS, a request message comprising a first ePCO IE. The operations of Step 802 may be performed in accordance with examples as described herein. In some implementations, aspects of the operations of Step 802 may be performed by a UE as described with reference to FIG. 5.

At Step 804, the method 800 may include receiving, from the network node, a response message comprising a second ePCO IE. The operations of Step 804 may be performed in accordance with examples as described herein. In some implementations, aspects of the operations of Step 804 may be performed by a UE as described with reference to FIG. 5.

At Step 806, the method 800 may include determining that the EPS supports UE policy sections management based on the second ePCO IE. The operations of Step 806 may be performed in accordance with examples as described herein. In some implementations, aspects of the operations of Step 806 may be performed by a UE as described with reference to FIG. 5.

At Step 808, the method 800 may include performing a network-requested UE policy management procedure in response to the determination that the EPS supports the UE policy sections management. The operations of Step 808 may be performed in accordance with examples as described herein. In some implementations, aspects of the operations of Step 808 may be performed by a UE as described with reference to FIG. 5.

It should be noted that the method 800 described herein describes one possible implementation, and that the operations and the steps may be rearranged or otherwise modified and that other implementations are possible.

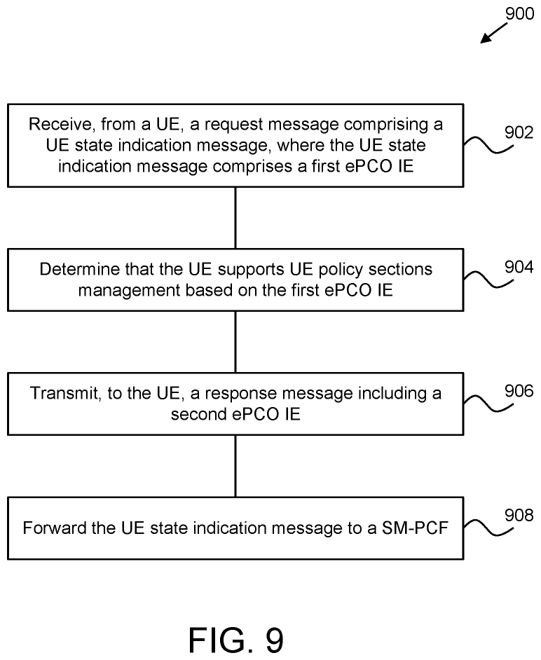

FIG. 9 illustrates a flowchart of a method 900 in accordance with aspects of the present disclosure. The operations of the method 900 may be implemented by a SMF+PGW-C entity as described herein. In some implementations, the SMF+PGW-C entity may execute a set of instructions to control the function elements of the SMF+PGW-C entity to perform the described functions.

At Step 902, the method 900 may include receiving, from a UE, a request message comprising a UE state indication message, where the UE state indication message comprises a first ePCO IE. The operations of Step 902 may be performed in accordance with examples as described herein. In some implementations, aspects of the operations of Step 902 may be performed by a NE as described with reference to FIG. 7.

At Step 904, the method 900 may include determining that the UE supports UE policy sections management based on the first ePCO IE. The operations of Step 904 may be performed in accordance with examples as described herein. In some implementations, aspects of the operations of Step 904 may be performed by a NE as described with reference to FIG. 7.

At Step 906, the method 900 may include transmitting, to the UE, a response message comprising a second ePCO IE. The operations of Step 906 may be performed in accordance with examples as described herein. In some implementations, aspects of the operations of Step 906 may be performed by a NE as described with reference to FIG. 7.

At Step 908, the method 900 may include forwarding the UE state indication message to a SM-PCF. The operations of Step 908 may be performed in accordance with examples as described herein. In some implementations, aspects of the operations of Step 908 may be performed by a NE as described with reference to FIG. 7.

It should be noted that the method 900 described herein describes one possible implementation, and that the operations and the steps may be rearranged or otherwise modified and that other implementations are possible.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
transmit, to a network node in an evolved packet system (EPS), a request message comprising a first extended protocol configuration options (ePCO) information element (IE);
receive, from the network node, a response message comprising a second ePCO IE;
determine that the EPS supports a UE policy sections management based on the second ePCO IE; and
perform a network-requested UE policy management procedure based on the EPS supporting the UE policy sections management.

2. The UE of claim 1, wherein the request message comprises an attach request message, and wherein the response message comprises an attach accept message.

3. The UE of claim 1, wherein the request message comprises a packet data network (PDN) connectivity request message, and wherein the response message comprises an activate default EPS bearer context request message or an activate dedicated EPS bearer context request message.

4. The UE of claim 1, wherein a payload of the first ePCO IE comprises a container having a particular container identifier (ID), wherein the particular container ID identifies that the container comprises a UE state indication message, and wherein the particular container ID, or contents of the container, or both, indicates support for the UE policy sections management.

5. The UE of claim 1, wherein a payload of the first ePCO IE comprises a first container having a first container identifier (ID), wherein a payload of the second ePCO IE comprises a second container having a second container ID different than the first container ID, and wherein the second container ID indicates that the network node supports the UE policy sections management in the EPS.

6. The UE of claim 1, wherein a payload of the second ePCO IE comprises a container, and wherein contents of the container indicate that the network node supports the UE policy sections management in the EPS.

7. The UE of claim 1, wherein the second ePCO IE comprises an indication that the network node supports UE route selection policy (URSP) provisioning over the EPS.

8. The UE of claim 7, wherein a payload of the second ePCO IE comprises a container having a container identifier (ID), and wherein the container ID, or contents of the container, or both, indicate that the network node supports the URSP provisioning over the EPS.

9. The UE of claim 1, wherein the network node comprises a combined session management function (SMF) and a packet data network gateway for control plane (PGW-C).

10. A method at a User Equipment (UE), the method comprising:
transmitting, to a network node in an evolved packet system (EPS), a request message comprising a first extended protocol configuration options (ePCO) information element (IE);
receiving, from the network node, a response message comprising a second ePCO IE;
determining that the EPS supports UE policy sections management based on the second ePCO IE; and
performing a network-requested UE policy management procedure based on the EPS supporting the UE policy sections management.

11. A network entity comprising a session management function (SMF), the network entity comprising:
at least one memory; and
at least one processor coupled with the at least one memory and configured to cause the SMF to:
receive, from a user equipment (UE), a request message comprising a UE state indication message, wherein the UE state indication message comprises a first extended protocol configuration options (ePCO) information element (IE);
determine that the UE supports UE policy sections management based on the first ePCO IE;
transmit, to the UE, a response message comprising a second ePCO IE; and
forward the UE state indication message to a session management policy control function (SM-PCF).

12. The network entity of claim 11, wherein the request message comprises a create session request message, and wherein the response message comprises a create session response message.

13. The network entity of claim 11, wherein a payload of the first ePCO IE comprises a container having a particular container identifier (ID), wherein the particular container ID identifies that the container comprises a UE state indication message, and wherein the particular container ID, or contents of the container, or both, indicate that the UE supports the UE policy sections management.

14. The network entity of claim 11, wherein a payload of the first ePCO IE comprises a first container having a first container identifier (ID), and wherein a payload of the second ePCO IE comprises a second container having a second container ID different than the first container ID.

15. The network entity of claim 14, wherein the second container ID indicates that the network entity supports the UE policy sections management.

16. The network entity of claim 11, wherein a payload of the second ePCO IE comprises a container, and wherein contents of the container indicate that the network entity supports the UE policy sections management.

17. The network entity of claim 11, wherein the second ePCO IE comprises an indication that the network entity supports UE route selection policy (URSP) provisioning.

18. The network entity of claim 17, wherein a payload of the second ePCO IE comprises a container having a container identifier (ID), and wherein the container ID or contents of the container, or both, indicates that the network entity supports the URSP provisioning.

19. The network entity of claim 11, wherein the network entity further comprises a packet data network gateway for control plane (PGW-C) combined with the SMF.

20. A method performed by a network entity, the method comprising:
receiving, from a User Equipment (UE), a request message comprising a UE state indication message, wherein the UE state indication message comprises a first extended protocol configuration options (ePCO) information element (IE);
determining that the UE supports UE policy sections management based on the first ePCO IE;
transmitting, to the UE, a response message comprising a second ePCO IE; and
forwarding the UE state indication message to a session management policy control function (SM-PCF).
